(19) United States
(12) Patent Application Publication
(10) Pub. No.: US 2019/0168962 A1
(43) Pub. Date: Jun. 6, 2019

(54) Waste Receptacle Assembly

(71) Applicant: Nicola Jennifer Smith, Lithonia, GA (US)

(72) Inventor: Nicola Jennifer Smith, Lithonia, GA (US)

(21) Appl. No.: 16/207,129

(22) Filed: Dec. 1, 2018

Related U.S. Application Data
(60) Provisional application No. 62/593,548, filed on Dec. 1, 2017.

(51) Int. Cl. B65F 1/06; B65F 1/14; B65F 1/16

(52) U.S. Cl. CPC B65F 1/068; B65F 1/065; B65F 1/1615; B65F 1/1473

(57) ABSTRACT

A waste receptacle assembly having a shell, a lid, and a pivotably attached door with a handle that opens outward. The inner shell of the waste receptacle assembly includes clips for securing a trash bag.

### CROSS-REFERENCE TO RELATED APPLICATION

This application claims priority to U.S. Provisional Application No. 62/593,548 filed on Dec. 1, 2017, the disclosure of which, including any materials incorporated by reference therein, is incorporated herein by reference in its entirety.

### TECHNICAL FIELD

The present invention relates generally to lawn and garden equipment. More particularly, the present invention concerns a heavy-duty trash can having a swing-open door.

### BACKGROUND

Large trash cans, particularly those that roll, are useful for many projects. From lawn care, gardening, regular trash, or recycling, such trash cans are convenient and even necessary for many uses. Because they are large they can contain many small items, or can accommodate larger items. And, with their wheels, they can be moved even when laden down by heavy contents. However, the task of emptying large trash cans can be arduous. Because of their size, it is often convenient to let them fill up before emptying them, and the total amount of their contents can be heavy, bulky, or unpleasant. Worse still, with traditional trash cans of this sort, a user is forced to lift a bag full of heavy materials straight up out of the trash can. This can be extremely difficult, and sometimes a user has to set the trash can on its side to drag out the heavy bag. Therefore, a need exists for a large trashcan with a swinging door configured such that a user may open the door and remove the trash can's bag straight out of the trash can's side much easier than lifting it straight up out of the trash can

Attempts have been made, although unsuccessfully, to solve this problem. One illustrative attempt can be seen with respect to U.S. Patent Application Publication No. 2001/0020619, incorporated by reference in its entirety herein, which generally discloses a trash can having one or more swing-top lids. While this disclosure does provide for easier entry to the trash bag(s), it still requires a user to lift the bag out of the can vertically.

Another attempt to meet this need can be seen with respect to U.S. Pat. No. 6,234,339, incorporated by reference in its entirety herein, which generally discloses a trash can having a swing-open front and a trash bag dispenser in its base. While this disclosure does provide for a swing-open door and make the re-bagging task easier, the configuration of the swing door as the entire front of the trash can means that a bag cannot be loaded with the door open, which limits the device's utility. The smaller size and lack of wheels also limit this disclosure.

Another attempt can be seen with respect to U.S. Pat. No. 4,577,778, incorporated by reference in its entirety herein, which generally discloses a trash can having an opening front and an extending trash bag holder. While this disclosure does provide for a front-opening swing door, it fails to provide for wheels or another way for it to be transported easily.

As can be seen, various attempts have been made to solve the problems which may be found in the related art but have been unsuccessful. A need exists for a new heavy-duty trash can having a swing-open door to avoid the challenges and problems with the prior art.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a receptacle, trash can, container, etc., are herein meant to include or encompass all equivalents for such elements. Such equivalents are contemplated for each element named in its particular herein.

Moreover, any item, object, or thing capable of being retained within the present invention may herein be referred to herein as a “waste,” including trash, rubbish, debris, junk, rubble, and so forth.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for collecting large items or significant quantities of items and easily removing a bag containing those items. The general purpose of the present invention, which shall be described subsequently in greater detail, is to enable a user to transport a large trash can using its built-in wheels, fill the large trash can with items, open the front of the trash can, and remove the bag from the front angle, rather than from the trash can's topside. The features of the invention are believed to be novel and to have been particularly pointed out and distinctly claimed in the concluding portion of the specification. These and other features, aspects, and advantages of the present invention will become better understood with reference to the following drawing and detailed description.

The features of the invention which are believed to be novel are particularly pointed out and distinctly claimed in the concluding portion of the specification. By way of non-limiting example, the present invention provides a novel solution for a waste receptacle. These and other features, aspects, and advantages of the present invention will become better understood with reference to the following drawings and detailed description.

While the invention will be described in connection with trash or recycling materials, it is understood that the invention is not limited in scope to use with trash or recycling materials, but may be used with other types of items, such as toys for a toy drive, canned goods or other foodstuffs for a food drive, lawn and leaf biodegradable materials, and any other item capable of being passed through the top lid of the present invention and collected into a bag.

The present invention comprises a heavy-duty trash can having a swing-open door. In some embodiments, the present invention provides for a receptacle having at least one side, at least one top lid, at least one swing-open door, and at least one base. In some embodiments, the present invention may provide for a trash can receptacle having four sides, at least tone top lid hingedly connected to a side, a base, at least one swing-open door disposed on one or more sides, and at least two wheels rotationally connected to the at least one base and/or one or more sides. In some embodiments, the exterior of one or more sides may also provide for one or more hooks, hoops, grooves, channels, protrusions, or other elements configured to enable a machine to lift and manipulate the trash can of the present invention, such as by way of illustration and not limitation, as may be used by a garbage truck to lift and empty large trash cans.

In some embodiments, the at least one swing-open door may be hingedly connected to at least one side, have an open position and a closed position, and when in the closed position, may comprise part of at least one side. The swing-open door may have one or more handles or latches configured to detachedly secure the swing-open door to at least one side, such that when detachably attached via the handle or the latch, the swing-open door may stay in a closed position.

The trash can of the present invention may be of any size known in the art. In some embodiments, the trash can may be of a large-project size or an industrial size, for example and not by way of limitation, the sizes for use with “lawn and garden” activities such as hauling debris or collecting grass cuttings, or the family or business industrial size whereupon a trash can of the present invention may be configured for use with city or private company pickup services.

In some embodiments, the present invention may comprise at least the elements of at least one top lid, a hinge or other rotational connection, and at least one trash can having four sides, an exterior and an interior, whereupon the hinge connection may connect to the top lid in any manner known in the art and to at least one side of the trash can in any manner known in the art, and may be configured to close facilitate the top lid rotating between an open position and a closed position.

The present invention may also provide for one or more clips, in some embodiments four clips, disposed on the interior side(s) of one or more trash can sides, wherein the clips may be configured to removably hold at least one trash bag. One or more additional clips or protrusions may be disposed on at least one side, wherein the additional clip(s) may be configured to keep the top lid ajar relative to at least one side.

The present invention may provide for at least one swing-open door having four sides. In some embodiments, when in the closed position, all four sides of the swing-open door may be configured to lie flush with one or more trash can sides or otherwise to comprise portions of one or more trash can sides. In other embodiments, the top side of the swing-open door may, when in the closed position, comprise the top side of one or more trash can sides.

The present invention may provide for one or more handles on the swing-open door, on one or more sides of the trash can, or both. One such handle may be configured to be disposed horizontally along the top portion of a rear trash can side, and may be configured to enable a user to tip the trash can by using the rear handle in conjunction with the wheels. The present invention may also provide for one or more wheels, in some embodiments two wheels, rotationally attached to the base, one or more sides, or both.

To use the present invention, a user may start by loading the present invention's trash can with a leaf bag and clipping it open. The user may then fill the can with leaves and transport them to the desired location. Upon reaching desired location, the user may swing the front door open and slide the full bag of leaves out onto the curb or other desired location without strain. The lid conveniently hinged on the back provides protection from rain in the event overnight or extended storage is needed. In the event that the location where the leaves are picked up is a great distance from where they were collected the user may be able to roll the can to the location rather than carry each bag. Once the user arrives, the user may be able to slide the bag out rather than lift it out, which could cause strain.

The unique features of this product will provide the following benefits for consumers everywhere: it provides for quick transportation of debris, makes it easier, safer, and faster to remove heavy bags from trash cans, can be used by residential families, apartment residences and even landscape companies and construction teams, heavy duty and portable, and has a multifunctional swing-open door.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### BRIEF DESCRIPTION OF THE DRAWINGS

These and other features, aspects and advantages of the present invention will become better understood with regard to the following description, appended claims, and accompanying figures where:

FIG. 1 shows an open front perspective view of a waste receptacle in accordance with an embodiment of the invention.

FIG. 2 shows a closed front perspective view of a waste receptacle in accordance with an embodiment of the invention.

FIG. 3 shows an open perspective view of a waste receptacle in accordance with an embodiment of the invention.

FIG. 4 shows an enlarged view of a waste receptacle in accordance with an embodiment of the invention.

FIG. 5 shows a rear perspective view of a waste receptacle in accordance with an embodiment of the invention.

### DETAILED DESCRIPTION

The present invention overcomes the limitations of the prior art by providing a new and more effective waste receptacle.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

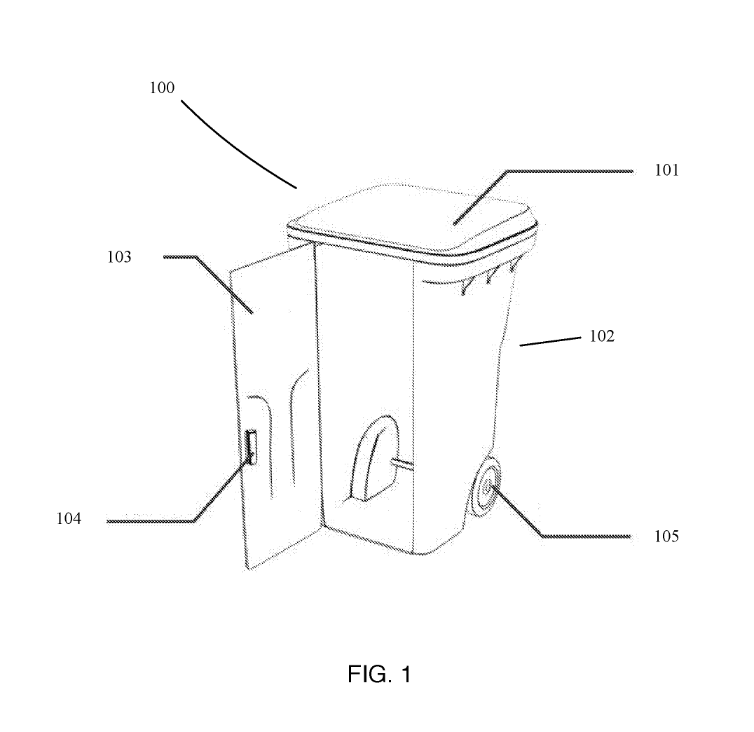

Turning attention to FIG. 1, an open front perspective view of a waste receptacle in accordance with an embodiment of the invention is shown. In the embodiment depicted, a viewer may perceive a waste receptacle 100 comprising a lid 101, a left side 102a a right side 102b and a rear side 102c. The front of the waste receptacle 100 is comprised of a hingeably attached door 103 with a handle 104. The rear side 102c of the waste receptacle 100 may have one or more wheels.

As may be noted by those of skill in the art, the waste receptacle 100 need not be generally rectangular as shown in FIG. 1, but rather in some embodiments the waste receptacle 100 may be circular, triangular, square or any other shape. Moreover, he waste receptacle 100 may be deeper or shallower, taller or shorter, or generally of another carrying capacity than generally disclosed in FIG. 1. Additionally, in some embodiments, he waste receptacle 100 may provide for one or more inner compartments (not shown) that may be generally configured, or that may be specially configured.

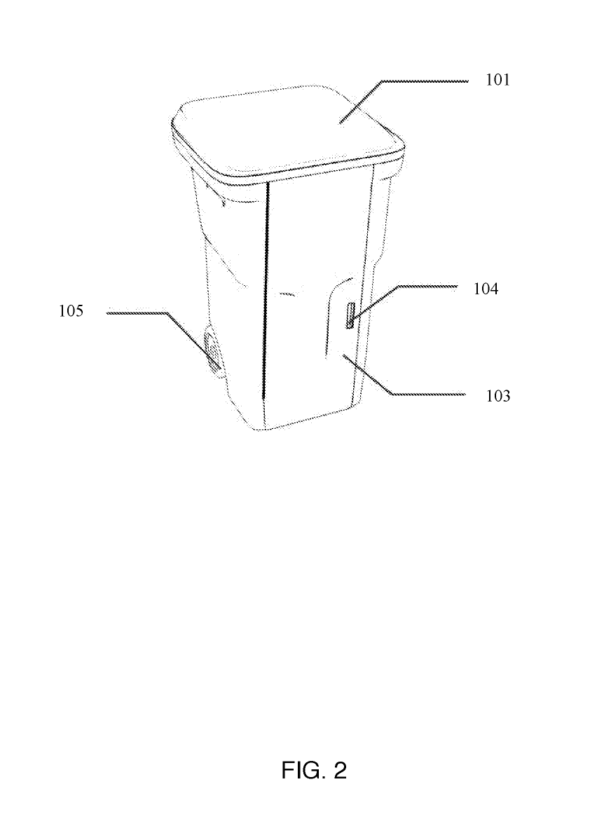

With respect to FIG. 2, a closed perspective view of a waste receptacle in accordance with an embodiment of the invention is shown. In the embodiment depicted, a viewer may perceive a waste receptacle 100 comprising a lid 101, a left side 102a a right side 102b and a rear side 102c. The front of the waste receptacle 100 is comprised of a pivotably attached door 103 with a handle 104. The rear side 102c of the waste receptacle 100 may have one or more wheel.

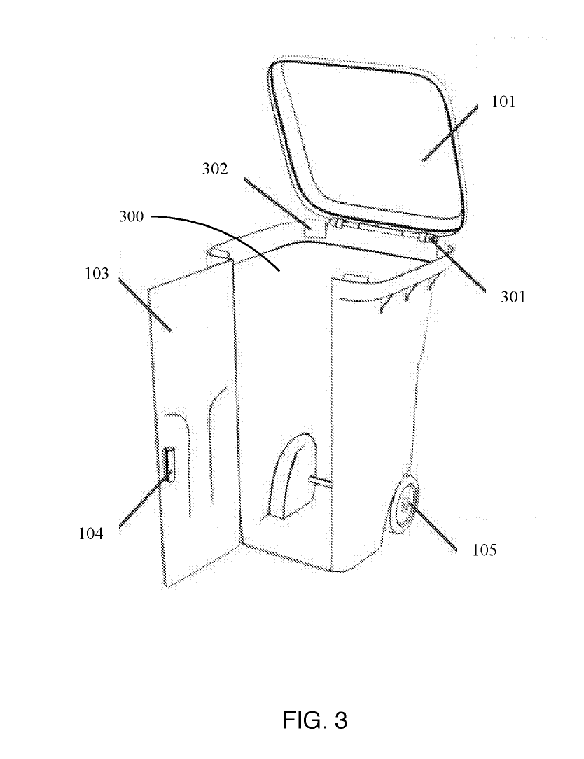

With regards to FIG. 3, an open perspective view of a waste receptacle in accordance with an embodiment of the invention is shown. In the embodiment depicted, a viewer may perceive the inner compartment 300 of the waste receptacle 100 having a connected lid 101 that is secured to the top member of the rear wall of the inner compartment 300 with two or more hinge connectors 301. In a preferred embodiment of the present invention, a viewer may perceive that the top member of the inner compartment contain two or more clips 302 to hold a trash bag (not shown) un place.

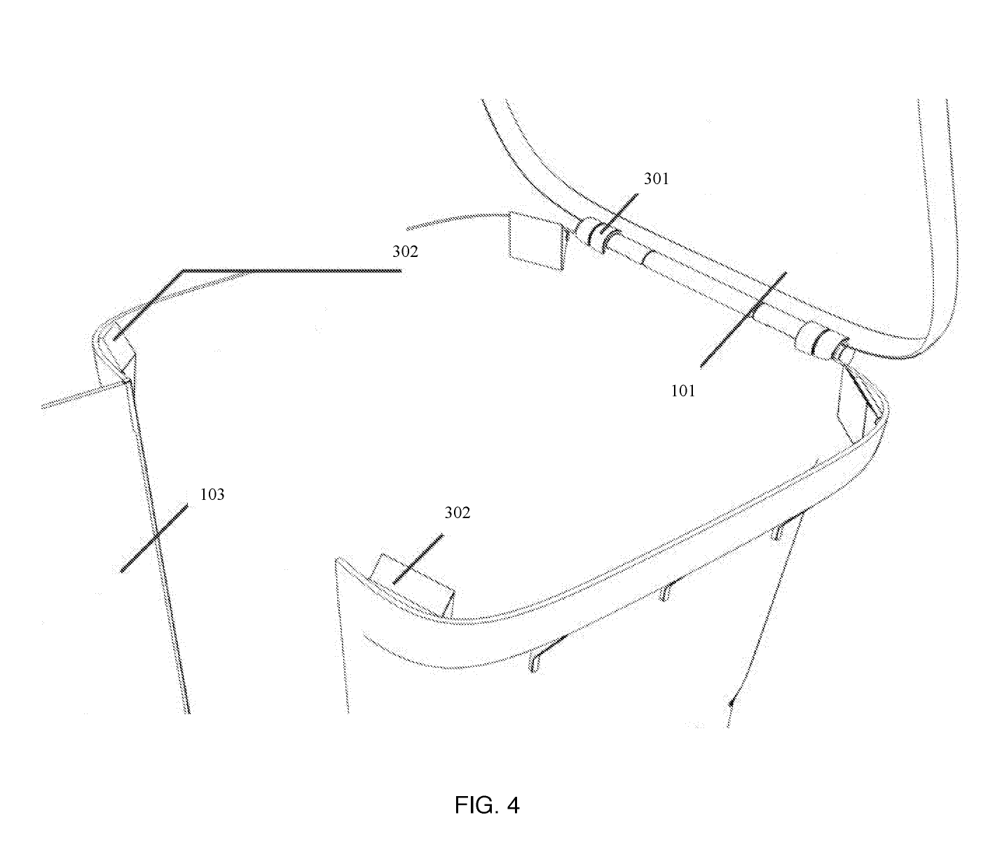

Turning attention to FIG. 4, an enlarged view of a preferred embodiment of the present invention is shown. In the embodiment depicted, a viewer may perceive the clips 302 secured to the inner corners of the inner compartment 300 of the waste receptacle 100. The clips 302 extend inward from the walls of the inner compartment 300 at an angle varying from 35 degrees to 65 degrees. A viewer may also perceive that the lid 100 is pivotably connected to the rear side 102c of the waste receptacle.

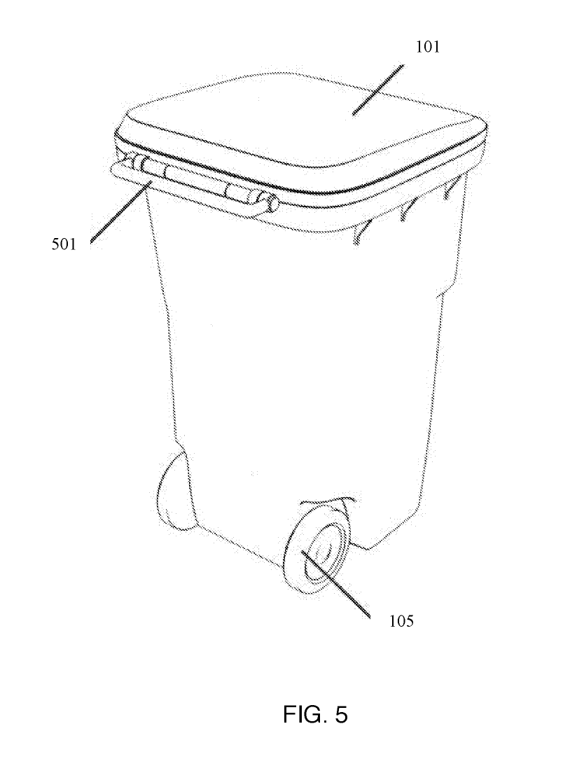

With regards to FIG. 5, a rear perspective view of a waste receptacle in accordance with an embodiment of the invention is shown. In the embodiment depicted, a viewer may perceive a waste receptacle 100 having a handle bar 501 on the rear side 102c of the hinge 301 that pivotably connects the lid 101 to rear side 102c of the waste receptacle.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention generally described herein has been disclosed in connection with a number of embodiments shown and described in detail, various modifications should be readily apparent to those of skill in the art.

What is claimed is:

1. A waste receptacle assembly comprising:
a shell having an open top edge, a recess cut from the left side of the shell extending to the right side of the shell, and an outer surface;
a lid pivotably connected to the rear wall of the shell proportionally sized to extend and fit over the open top edge;
a door pivotably connected to the open edge of a side wall of the shell and extending to the open edge of the opposite side wall; and
at least two fasteners connectably attached to the inner facing surface of the shell.

2. The waste receptacle assembly of claim 1, wherein the at least two fasteners extend inward at least at a 35-degree angle.

3. The waste receptacle assembly of claim 1, wherein the door has a handle.
